(19) United States
(12) Patent Application Publication
(10) Pub. No.: US 2021/0197473 A1
(43) Pub. Date: Jul. 1, 2021

(54) REDUCING VIBRATIONAL SOUNDS PRODUCED DURING EVACUATION PROCESSES

(71) Applicant: HEWLETT-PACKARD DEVELOPMENT COMPANY, L.P., Spring, TX (US)

(72) Inventors: Duane A. KOEHLER, Vancouver, WA (US); Charles Hugh OPPENHEIMER, Vancouver, WA (US)

(73) Assignee: HEWLETT-PACKARD DEVELOPMENT COMPANY, L.P., Houston, TX (US)

(21) Appl. No.: 16/075,212

(22) PCT Filed: Apr. 19, 2017
(86) PCT No.: PCT/US2017/028364

§ 371 Date: Aug. 3, 2018

(51) Int. Cl. B29C 64/35; B29C 64/386; B33Y 40/20; B33Y 50/00; B08B 7/02; B08B 13/00; G10K 11/178

(52) U.S. Cl. CPC B29C 64/35; B29C 64/386; B33Y 40/20; B33Y 50/00; B08B 7/02; G10K 2210/3027; G10K 11/17823; G10K 11/17883; G10K 2210/129; G10K 2210/3025; G10K 2210/3026; B08B 13/00

(57) ABSTRACT

An additive manufacturing device for reducing vibrational sounds produced during an evacuation process includes a shaker connected to a build area of the additive manufacturing device, the shaker to vibrate the build area during the evacuation process to separate fused and non-fused build material of a cake and an exciting transducer to transmit a reducing signal during the evacuation process such that the reducing signal reduces vibrational sounds produced by the shaker before the vibrational sounds reaches a user.

### BACKGROUND

An additive manufacturing device is used to fabricate a three-dimensional (3D) object. The additive manufacturing device fabricates the 3D object by depositing layers of build material corresponding to slices of a computer-aided design (CAD) model that represents the 3D object. Some additive manufacturing devices are referred to as 3D printing devices because they use types of printing technology to deposit some of the manufacturing materials.

### BRIEF DESCRIPTION OF THE DRAWINGS

The accompanying drawings illustrate various examples of the principles described herein and are a part of the specification. The examples do not limit the scope of the claims.

FIG. 1A is a diagram of an additive manufacturing apparatus for reducing vibrational sounds produced during an evacuation process, according to one example of principles described herein.

FIG. 1B is a diagram of a system for reducing vibrational sounds produced during an evacuation process, according to one example of principles described herein.

FIG. 1C is a diagram of a system for reducing vibrational sounds produced during an evacuation process, according to one example of principles described herein.

FIG. 2A is a diagram of an additive manufacturing apparatus for reducing vibrational sounds produced during an evacuation process, according to one example of principles described herein.

FIG. 2B is a diagram of a system for reducing vibrational sounds produced during an evacuation process, according to one example of principles described herein.

FIG. 2C is a diagram of a system for reducing vibrational sounds produced during an evacuation process, according to one example of principles described herein.

FIG. 3A is a diagram of a system for reducing vibrational sounds produced during an evacuation process, according to one example of principles described herein.

FIG. 3B is a diagram of a system for reducing vibrational sounds produced during an evacuation process, according to one example of principles described herein.

FIG. 3C is a diagram of a system for reducing vibrational sounds produced during an evacuation process, according to one example of principles described herein.

FIG. 4 is an alternate diagram of a system for reducing vibrational sounds produced during an evacuation process, according to one example of principles described herein.

FIG. 5A is a feedforward control diagram for reducing vibrational sounds produced during an evacuation process, according to one example of principles described herein.

FIG. 5B is a feedback control diagram for reducing vibrational sounds produced during an evacuation process, according to one example of principles described herein.

FIG. 5C is a system diagram for reducing vibrational sounds produced during an evacuation process, according to one example of principles described herein.

FIG. 6 is a flowchart of a method for reducing vibrational sounds produced during an evacuation process, according to one example of principles described herein.

FIG. 7 is a flowchart of a method for reducing vibrational sounds produced during an evacuation process, according to one example of principles described herein.

Throughout the drawings, identical reference numbers designate similar, but not necessarily identical, elements.

### DETAILED DESCRIPTION

As mentioned above, an additive manufacturing device fabricates a three-dimensional (3D) object from a computer-aided design (CAD) model representing the 3D object. Once the CAD model of the 3D model is created, the CAD model is processed into a number of slices. Each of the slices, or a number of the slices, corresponds to a layer of the 3D object to be fabricated by the additive manufacturing device. The additive manufacturing device fabricates a portion of the 3D object by depositing a first layer of build material representing at least the first slice of the CAD model. The additive manufacturing device then fabricates subsequent portions of the 3D object by depositing subsequent layers of the build material representing subsequent slices of the CAD model on top of the first layer until the 3D object is fabricated.

Once the additive manufacturing device finishes the fabrication process, the additive manufacturing device has produced a cake. The cake is a combination of fused build material such as the fabricated 3D object and non-fused build material such as residual build material, such as powder. It is desirable to remove the non-fused build material from the 3D object.

To remove the non-fused build material from the 3D object, the additive manufacturing device executes an evacuation process. One of the procedures of the evacuation process includes using a shaker connected to a build area of the additive manufacturing device to vibrate the build area. This cracks the cake for cooling purposes and separates the fused build material and the non-fused build material of the cake. During this procedure, the evacuation process produces a vibrational sound that is loud and typically between 40 to 70 hertz. This vibrational sound tends to be omni-directional and penetrates through walls due to its low frequency. The vibrational sound is also difficult to muffle using passive means noise controls like barriers, absorptive material, or resilient vibration isolating mounts due to the low frequency of the vibrational sound. The vibrational sound is therefore not only present at the additive manufacturing device, but may transmit to, for example to people who are in adjacent areas of the building where the additive manufacturing device is located.

To reduce the vibrational sound, soundproofing materials or administrative controls can be used. For example, soundproofing material such as barrier baffling and insulation material can be added in the walls or ceilings of the building or to the additive manufacturing device to reduce the vibrational sound. However, this increases the overall cost of the building and the additive manufacturing device. Due to the low frequencies of the vibrational sound, soundproofing material is not particularly effective at blocking or absorbing the vibrational sound, as noted above, and therefore needs very thick blocking walls and/or absorptive batts. It also forces compromises in industrial design and needing very thick soundproofing material places limitations on materials used for case parts of the additive manufacturing device. In other examples, the additive manufacturing device is used after business hours so as to not bother other people that are in adjacent areas of the building where the additive manufacturing device is located. This can be burdensome on the business since most business need to fabricate a 3D object during business hours.

The principles described herein include an additive manufacturing device. The additive manufacturing device includes a shaker connected to a build area of the additive manufacturing device, the shaker to vibrate the build area during the evacuation process to separate fused and non-fused build material of a cake and an exciting transducer to transmit a reducing signal during the evacuation process such that the reducing signal reduces vibrational sounds produced by the shaker before the vibrational sounds reaches a user.

In another example, the principles described herein include system for reducing vibrational sounds produced during an evacuation process. The system includes a shaker connected to a build area of an additive manufacturing device, the shaker to vibrate the build area during the evacuation process to separate fused and non-fused build material of a cake and an array of exciting transducers to transmit a reducing signal during the evacuation process towards the build area such that the reducing signal reduces the vibrational sounds produced by the shaker. The array of exciting transducers at least partially reduce amplitude of at least one specific frequency of the vibrational sounds via the reducing signal.

In another example, the principles described herein include a method for reducing vibrational sounds produced during an evacuation process. The method includes with a shaker connected to a build area of an additive manufacturing device, vibrating the build area during the evacuation process to separate fused and non-fused build material of a cake, with a processor and memory, determining a reducing signal that at least partially reduces amplitude of at least one specific frequency of the vibrational sounds produced by the shaker during the evacuation process, and with an exciting transducer, transmitting the reducing signal during the evacuation process towards the build area such that the reducing signal reduces the vibrational sounds.

In the present specification and in the appended claims, the term “cake” means a combination of fused build material and non-fused build material. In an example, the fused build material is a fabricated 3D object and the non-fused build material is residual build material.

In the present specification and in the appended claims, the term “exciting transducer” means a device that transmits a reducing signal. The exciting transducer can be a loudspeaker that produces a reducing signal that is air-borne. The exciting transducer can be a vibration actuator that produces a reducing signal that is structure-borne.

In the present specification and in the appended claims, the term “shaker” means a device that produces vibrational sounds. The shaker can be a loud speaker, a vibration actuator, or both. As a result, the vibrational sounds can be air-borne or structure-bome.

In the present specification and in the appended claims, the term “vibrational sounds” means an undesired noise produced during an evacuation process. The vibrational sounds are produced by a vibrational component vibrating a build area during an evacuation process. In some examples, the vibrational sounds are airborne, structure-borne, or combinations thereof.

In the present specification and in the appended claims, the term “evacuation process” means a process that separates the fused build material and the non-fused build material. The evacuation process includes causing a shaker driven at specific frequencies to crack the cake so the cake can cool more rapidly, separate fused and non-fused build material of a cake, sorting the non-fused build material as either reusable or non-reusable and recycling the reusable non-fused build material.

In the present specification and in the appended claims, the term “reducing signal” means an audio and/or mechanical signal that is to at least partially reduce amplitude of at least one specific frequency of vibrational sounds. In some examples, the reducing signal is to at least partially reduce amplitude of at least one specific frequency of the vibrational sounds inside of an additive manufacturing apparatus such that the specific frequency is reduced from a perspective of a user located outside of the additive manufacturing apparatus. The reducing signal is directed towards a build area such that the sound waves produced by the reducing signal and sound waves of vibrational sounds interact outside the cake. As a result, the reducing signal does not adversely affect the evacuation process for the cake. Further, the vibrational sounds are reduced before reaching a user located external to the additive manufacturing apparatus. In some example, the reducing signal inversely matches a vibration pattern of the cake during the evacuation process. Since the vibrational sounds are airborne, structure-borne, or combinations thereof, the reducing signal can be airborne, structure-borne, or combinations thereof.

Examples provided herein include apparatuses, processes, and methods for generating three-dimensional objects. Devices for generating three-dimensional objects may be referred to as additive manufacturing devices. As will be appreciated, example devices described herein may correspond to three-dimensional printing systems, which may also be referred to as three-dimensional printers. In an example, additive manufacturing process, a layer of build material may be formed in a build area, a fusing agent may be selectively distributed on the layer of build material, and energy may be temporarily applied to the layer of build material. As used herein, a build layer may refer to a layer of build material formed in a build area upon which agent may be distributed and/or energy may be applied.

Additional layers may be formed and the operations described above may be performed for each layer to thereby generate a 3D object. Sequentially layering and fusing portions of layers of build material on top of previous layers may facilitate generating three-dimensional objects. The layer-by-layer formation of a three-dimensional object may be referred to as a layer-wise additive manufacturing process.

In examples described herein, a build material may include a powder-based build material, where powder-based build material may include wet and/or dry powder-based materials, particulate materials, and/or granular materials. In some examples, the build material may be a weak light absorbing polymer. In some examples, the build material may be a thermoplastic or other material such as metals. Furthermore, as described herein, agent may include liquids that may facilitate fusing of build material when energy is applied. In some examples, agent may be referred to as coalescing or fusing agent. In some examples, agent may be a light absorbing liquid, an infrared or near infrared absorbing liquid, such as a pigment colorant. In some examples at least two types of agent may be selectively distributed on a build layer. In some examples at least one agent may inhibit fusing of build material when energy is applied.

Example apparatuses may include an agent distributor. In some examples, an agent distributor may include at least one liquid ejection device. A liquid ejection device may include at least one printhead (e.g., a thermal ejection based printhead, a piezoelectric ejection based printhead, etc.). An agent distributor may be coupled to a scanning carriage, and the scanning carriage may move along a scanning axis over the build area. In one example, printheads suitable for implementation in commercially available inkjet printing devices may be implemented as an agent distributor. In other examples, an agent distributor may include other types of liquid ejection devices that selectively eject small volumes of liquid.

In some examples, an agent distributor may include at least one liquid ejection device that includes a plurality of liquid ejection dies arranged generally end-to-end along a width of the agent distributor. In some examples, the at least one liquid ejection device may include a plurality of printheads arranged generally end-to-end along a width of the agent distributor. In such examples, a width of the agent distributor may correspond to a dimension of a build area. For example, a width of the agent distributor may correspond to a width of a build area. As will be appreciated, an agent distributor may selectively distribute agent on a build layer in the build area concurrent with movement of the scanning carriage over the build area. In some example devices, the agent distributor may include nozzles including nozzle orifices through which agent may be selectively ejected. In such examples, the agent distributor may include a nozzle surface in which a plurality of nozzle orifices may be formed.

In some examples, apparatuses may include a build material distributor to distribute build material in the build area. A build material distributor may include, for example, a wiper blade, a roller, and/or a spray mechanism. In some examples, a build material distributor may be coupled to a scanning carriage. In these examples, the build material distributor may form build material in the build area as the scanning carriage moves over the build area along the scanning axis to thereby form a build layer of build material in the build area.

Further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

While the figures describe a specific number of exciting transducers, such as loudspeakers and vibration actuators, and sensing transducers, such as microphones and accelerometers to receive the vibrational sounds or signals generated by the drivers, in practice, any number of exciting transducers could be used. For example, one exciting transducer and sensing transducer could be used. In another example, one exciting transducer and multiple sensing transducers could be used. In yet another example, multiple exciting transducers and one sensing transducers could be used. In another example, multiple exciting transducers and multiple sensing transducers. Again, the vibrational sounds and reducing signal can be air-bome, structure-borne, or both.

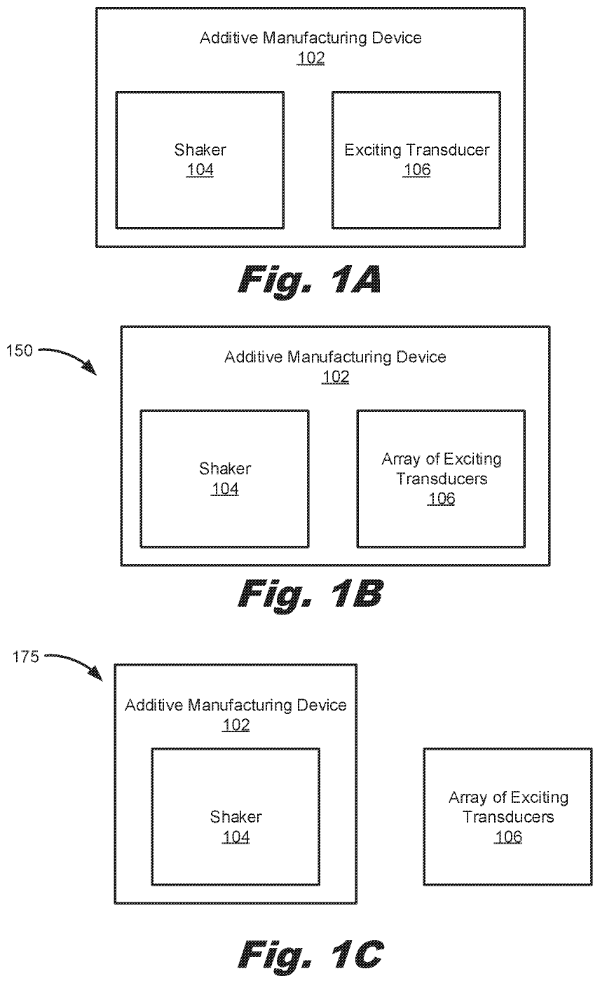

Referring now to the figures, FIG. 1A is a diagram of an additive manufacturing apparatus for reducing vibrational sounds produced during an evacuation process, according to one example of principles described herein. As will be described below, the additive manufacturing apparatus (102) includes a shaker (104) and an exciting transducer (106).

The additive manufacturing device (102) includes a shaker (104) connected to a build area (112) of the additive manufacturing device (102), the shaker (104) to vibrate the build area (112) during the evacuation process to separate fused and non-fused build material of a cake (114).

The additive manufacturing device (102) includes an exciting transducer (106) to transmit a reducing signal during the evacuation process such that the reducing signal reduces vibrational sounds produced by the shaker (104) before the vibrational sounds reach a user.

FIG. 1B is a diagram of a system for reducing vibrational sounds produced during an evacuation process, according to one example of principles described herein. As will be described below, the additive manufacturing apparatus (102) includes a shaker (104) and an array of exciting transducers (106). In this example, the array of exciting transducers (106) is located within the additive manufacturing apparatus (102).

As illustrated, the system (150) includes a shaker (104) connected to a build area (112) of the additive manufacturing device (102), the shaker (104) to vibrate the build area (112) during the evacuation process to separate fused and non-fused build material of a cake (114).

The system (150) includes an array of exciting transducers (106) to transmit a reducing signal during the evacuation process towards the build area (112) such that the reducing signal reduces the vibrational sounds produced by the shaker (104). In an example, the array of exciting transducers (106) at least partially reduce amplitude of at least one specific frequency of the vibrational sounds via the reducing signal.

FIG. 1C is a diagram of a system for reducing vibrational sounds produced during an evacuation process, according to one example of principles described herein. As will be described below, the additive manufacturing apparatus (102) includes a shaker (104) and an array of exciting transducers (106). In this example, the array of exciting transducers (106) is located external to the additive manufacturing apparatus (102).

As illustrated, the system (175) includes a shaker (104) connected to a build area (112) of the additive manufacturing device (102), the shaker (104) to vibrate the build area (112) during the evacuation process to separate fused and non-fused build material of a cake (114).

The system (175) includes an array of exciting transducers (106) to transmit a reducing signal during the evacuation process towards the build area (112) such that the reducing signal reduces the vibrational sounds produced by the shaker (104). In an example, the array of exciting transducers (106) at least partially reduce amplitude of at least one specific frequency of the vibrational sounds via the reducing signal.

While the figures describe the reducing signal interacting with the vibrational sounds at walls (110) of a build chamber (134) such that the reducing signal reduces the vibrational sounds produced by the shaker (104) at the walls (110), the reducing signal may interact with the vibrational sounds at other locations. These locations may be internal to the additive manufacturing device (102) or external to the additive manufacturing device (102). In some examples, exciting transducers (106) excites the air inside the case (108) to attenuate the vibrational sounds outside the cake (114) and inside the case (108), thereby also attenuating the vibrational sounds outside the case (108). The reducing signal and the vibrational sounds are to interact with each other based on two criteria. First the reducing signal and the vibrational sounds are to interact such that the reducing signal does not adversely affect the evacuation process for the cake. As a result, some of the examples describe the reducing signal interacting with the vibrational sounds inside of the case (108). Second, the vibrational sounds are reduced before reaching a user located external to the additive manufacturing apparatus (102). In some examples, the reducing signal interacts with the vibrational sounds internal or external to the additive manufacturing device (102). Further, the reducing signal transmitted by the exciting transducers in the air between the build chamber (134) and the case (108) destructively interferes with the vibration sounds generated during the evacuation process when the vibration sounds is airborne. If the vibration sounds is structure-bome, the reducing signal destructively interferes with the vibration sounds generated during the evacuation process when the vibration sounds is structure-bome. As a result, in all examples, the reducing signal and the vibrational sounds interact such that the vibrational sounds are reduced before reaching a user.

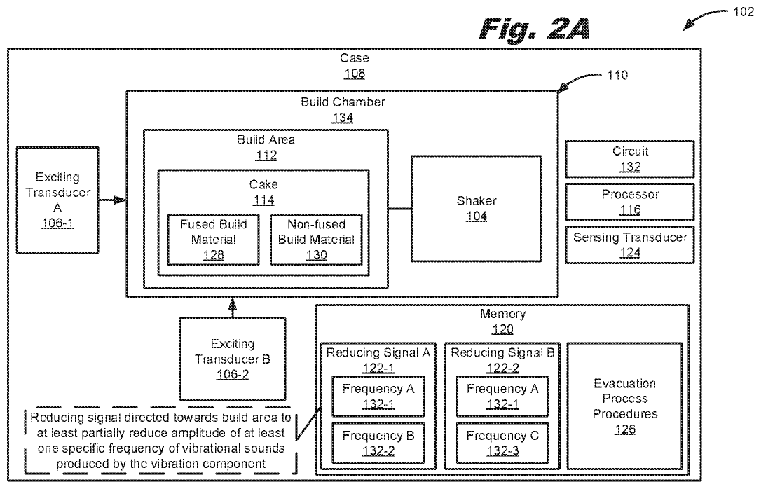

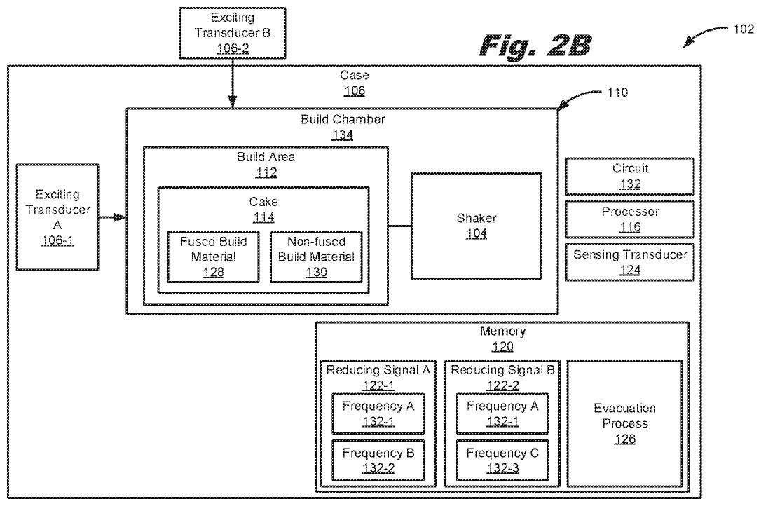

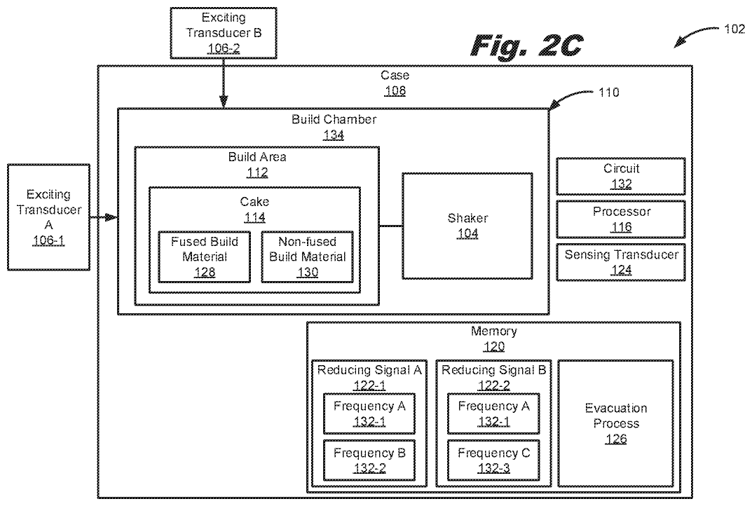

FIG. 2A is a diagram of an additive manufacturing apparatus for reducing vibrational sounds produced during an evacuation process, according to one example of principles described herein. As will be described below, a reducing signal is used to reduce vibrational sounds produced during an evacuation process.

As illustrated, the additive manufacturing apparatus (102) includes a case (108). The case (108) is an enclosure that contains the main components of the additive manufacturing apparatus (102). In an example, the case (108) is made out of materials such as metals, plastics, and resins. The case (108) gives the additive manufacturing apparatus (102) form and provides a platform for the main components of the additive manufacturing apparatus (102).

The additive manufacturing apparatus (102) includes a number of walls (110). The walls (110) are a structure within the case (108) that defines the build chamber (134). In this example, the walls (110) include four sides. The build chamber (134) includes a bottom and a top. The build chamber (134) is used to confine build material to specific areas of the additive manufacturing apparatus (102) during fabrication of a 3D object.

As illustrated, internal to the walls (110) of the build chamber (134) is a build area (112). The build area (112) is a location where the cake (114) is fabricated. The cake (114) is a combination of the fused build material (128) such as the fabricated 3D object and the non-fused build material (130) such as the residual build material.

In an example, a shaker (104) is located inside of the build chamber (134). The shaker (104) is connected to the build area (112). In one example, the shaker (104) is a mechanical device such as a motor with a counter weight that vibrates the build area (112). In another example, the shaker (104) is an acoustical transducer that vibrates the build area (112). The shaker (104) vibrates the build area (112) during an evacuation process (126). Procedures (126) of the evacuation process are stored in memory (120) such that a processor (116) and the memory (120) can drive the shaker (104) and execute each procedure of the evacuation process. The evacuation process separates the fused build material (128) and the non-fused build material (130) of the cake (114) via vibration. The evacuation process includes sorting the non-fused build material as either reusable or non-reusable and recycling the reusable non-fused build material. The evacuation process produces a vibrational sound that is loud and typically between 40 to 70 hertz. In some examples, the vibrational sound produced during the evacuation process is deterministic and not random. For example, the vibrational sound is actively produced under firmware control. This allows the vibrational sounds to be characterized.

To reduce the vibrational sounds produced by the shaker (104), the additive manufacturing apparatus (102) includes an array of exciting transducers (106). For example, the additive manufacturing apparatus (102) includes exciting transducer A (106-1) and exciting transducer B (106-2).

During the evacuation process, the exciting transducers (106) transmit a reducing signal during the evacuation process towards the build area (112) such that the reducing signal reduces vibrational sounds produced by the shaker (104). More information about the reducing signal will be described below.

In some examples, the exciting transducers (106) are located between the case (108) of the additive manufacturing device (102) and the walls (110) of the build chamber (114). As will be described in other parts of this specification, the location of the exciting transducers (106) can vary. Although not illustrated, the exciting transducers (106) are enclosed by a case such that when the cake (114) vibrates, components of the exciting transducers (106) are not affected by a change in airflow. This prevents the reducing signal from being altered when transmitted.

In an example, the sound emitting sides of a first portion of the exciting transducers, such as exciting transducer A (106-1) are positioned at an obtuse angle relative to sound emitting sides of a second portion of the exciting transducers such as such as exciting transducer B (106-2). In this example, the obtuse angle between 90 and 180 degrees.

As mentioned above, during the evacuation process, the exciting transducers (106) transmit a reducing signal. In an example, the reducing signal is predetermined at time of manufacture of the additive manufacturing device (102).

In this example, the reducing signal is predetermined at time of manufacture of the additive manufacturing device (102) by characterizing an acoustical signature of the additive manufacturing device (102) to identify frequencies of the vibrational sounds during the evacuation process. In this example, the additive manufacturing device (102) is placed in an acoustically controlled environment. Audio equipment such as microphones are placed inside and around the additive manufacturing device (102) to measure the vibration sounds produced by the shaker (104) during the evacuation process in real time. Since the evacuation process is firmware controlled, the vibration sounds produced during the evacuation process are predictable. As a result, the vibration sounds produced in this controlled environment are the same when the additive manufacturing device (102) is located in other environments.

As mentioned above, the frequencies of the vibrational sounds are between 40 and 70 hertz. In some examples, harmonics and/or subharmonics in this frequency range are unpleasant to a human ear while other harmonics and/or subharmonics in this frequency range are pleasant to the human ear. As a result, some harmonics and/or subharmonics are to be reduced via the reducing signal and other harmonics and/or subharmonics may not need to be reduced. In continuing with this example, based on the frequencies of the vibrational sounds, specific frequencies that are to be reduced are determined. For example, if the vibrational sounds include frequencies such as 40 hertz, 53 hertz and 70 hertz, it may be desirable to reduce the 53 hertz frequency.

In keeping with the example, the reducing signals frequencies are set. This includes setting the specific frequencies for the reducing signal such that the reducing signal at least partially reduces amplitude of the vibrational sounds at the specific frequencies associated with the vibrational sounds. For example, the specific frequencies include the 53 hertz frequency and any harmonics and/or subharmonics associated with this frequency.

Once the reducing signal is determined, the reducing signal is stored in memory (120). In this example, the memory (120) stores reducing signal A (122-1) and reducing signal B (122-2) in memory (120). In an example, the vibration sounds include frequency one, frequency two and frequency three.

In one example, reducing signal A (122-1) includes frequency A (132-1) and frequency B (132-2). Frequency A (132-1) and frequency B (132-2) reduce the amplitude of frequency one and frequency two respectively. As a result, when the exciting transducers (106) transmit reducing signal A (122-1) during the evacuation process towards the build area (112), reducing signal A (122-1) reduces vibrational sounds produced by the shaker (104) for frequency one and frequency two. In this example, reducing signal A (122-1) does not reduce frequency three.

In another example, reducing signal B (122-2) includes frequency A (132-1) and frequency C (132-3). Frequency A (132-1) and frequency C (132-3) reduce the amplitude of frequency one and frequency three respectively. As a result, when the exciting transducers (106) transmit reducing signal B (122-2) during the evacuation process towards the build area (112), reducing signal B (122-2) reduces vibrational sounds produced by the shaker (104) for frequency one and frequency three. In this example, reducing signal B (122-2) does not reduce frequency two.

In yet another example, the memory (120) can store other reducing signal such that other frequencies or all frequencies of the vibrational sounds can be reduced. For example, the memory (120) can store another reducing signal that reduces all frequencies of the vibrational sounds. Once the system is characterized and an optimal location of the exciting transducers is determined, the system can be tuned with firmware algorithms. This reduces the likelihood of multiple build, test and fix cycles during implementation.

In an example, the reducing signal is produced during the evacuation process. To do this, a sensing transducer (124), such as a microphone, receives vibrational sounds during the evacuation process. A circuit (132) determines specific frequencies of the vibrational sounds that are to be reduced and sets the magnitude and phase of these frequencies in the reducing signal such that the reducing signal attenuates the vibrational sounds at the specific frequencies associated with the vibrational sounds. This reducing signal is sent, via a processor (116) to the exciting transducers (106) to transmit the reducing signal during the evacuation process.

In some example, the reducing signal at least partially reduces amplitude of the vibrational sounds at all frequencies associated with the vibrational sounds. In other examples, the reducing signal at least partially reduces amplitude of at least one specific frequency of the vibrational sounds.

While this example has been described with reference to components being located in specific areas of the additive manufacturing device, the components can be located in other areas. For example, the shaker (104) can be located external to the build chamber (134).

FIG. 2B is a diagram of a system for reducing vibrational sounds produced during an evacuation process, according to one example of principles described herein. While FIG. 2A illustrates the exciting transducers (106) as being located between the case (108) and the walls (110), FIG. 2B illustrates the exciting transducers (106) being located in other locations.

As illustrated, an array of exciting transducers (106) is used to transmit the reducing signal. In an example, a first portion of the array of exciting transducers, such as exciting transducers A (106-1), is located between the case (108) of the additive manufacturing device (102) and the walls (110) of the build chamber (114). A second portion of the array of exciting transducers, such as exciting transducers B (106-2), is located external to the additive manufacturing device (102). Further, the sound emitting sides of the exciting transducers (106) are directed towards the build area (112) as indicated by the arrows pointing from the exciting transducers (106) to the build chamber (134).

FIG. 2C is a diagram of a system for reducing vibrational sounds produced during an evacuation process, according to one example of principles described herein. While FIG. 2A illustrates the exciting transducers (106) as being located between the case (108) and the walls (110) and FIG. 2B illustrates the exciting transducers (106) being located between the case (108) and the walls (110) and external to the additive manufacturing device (102), FIG. 2C illustrates the exciting transducers (106) being located external to the additive manufacturing device (102).

As illustrated, an array of exciting transducers (106) is used to transmit the reducing signal. In this example, the array of the exciting transducers (106) is located external to the additive manufacturing device (102). Further, the sound emitting sides of the exciting transducers (106) are directed towards the build area (112) as indicated by the arrows pointing from the exciting transducers (106) to the build chamber (134).

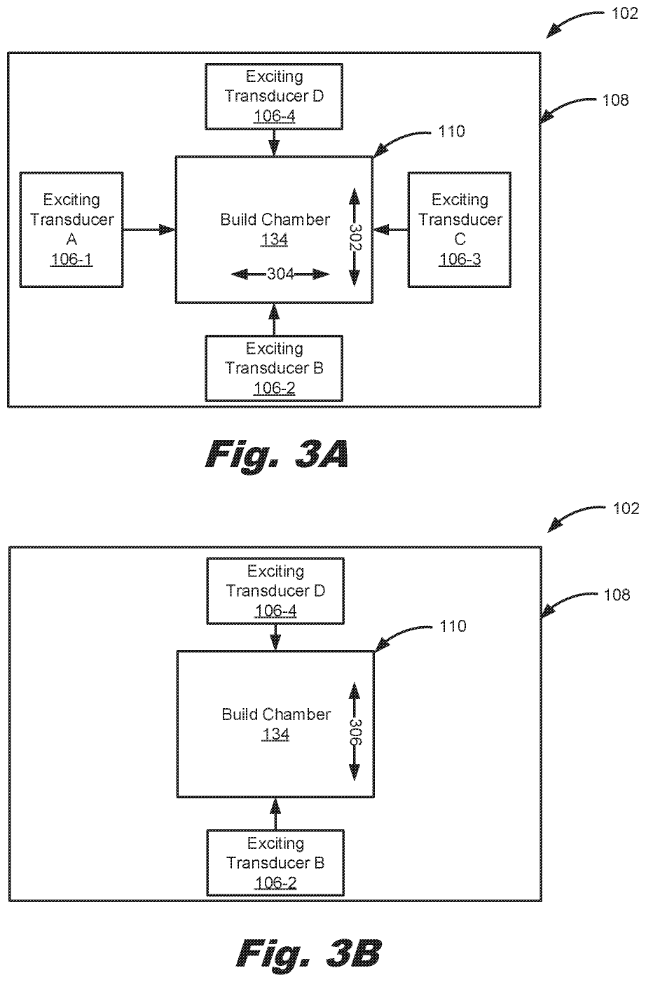

FIG. 3 represent simplified versions and variations of FIG. 2. As a result, some components illustrated in FIG. 2 are not illustrated in FIG. 3. However, it should be understood that FIG. 3 include those components.

FIG. 3A is a diagram of a system for reducing vibrational sounds produced during an evacuation process, according to one example of principles described herein. As will be described below, four exciting transducers (106) are used to transmit the reducing signal.

In an example, the vibrational sounds travel in the directions of arrow 302 and 304 when the shaker (104) vibrates. This causes the walls (110) of the build chamber (134) to oscillate in these directions. In an example, four exciting transducers (106) are used to transmit the reducing signal. The sound emitting sides of the four exciting transducers (106) are directed towards each of the walls (110) of the build chamber (134). The reducing signal is transmitted towards the walls (110) of the build chamber (134), as indicated by the arrow associated from the sound emitting sides of the four exciting transducers (106), such that the reducing signal at least partially reduces amplitude of the vibrational sounds. In this example, the reducing signal emitted from the four exciting transducers (106) excites the air inside the case (108) to attenuate the vibrational sounds outside the cake (114) and inside the case (112), thereby also attenuating the vibrational sounds outside the case (112). As a result, the vibrational sounds are reduced inside of the additive manufacturing device (102). In some examples, it is desirable not to adversely affect the evacuation process for the cake (114). As a result, the reducing signal is such that the reducing signal does not propagate into the build area (112).

FIG. 3B is a diagram of a system for reducing vibrational sounds produced during an evacuation process, according to one example of principles described herein. As will be described below, two exciting transducers (106) are used to transmit the reducing signal.

In an example, the vibrational sounds travel in the directions of arrow 306 when the shaker (104) vibrates. This causes the walls (110) of the build chamber (134) to oscillate in these directions. In an example, two exciting transducers (106) are used to transmit the reducing signal. The sound emitting sides of the two exciting transducers (106) are directed towards each of the walls (110) of the build chamber (134). The reducing signal is transmitted towards the walls (110) of the build chamber (134), as indicated by the arrow associated from the sound emitting sides of the two exciting transducers (106), such that the reducing signal at least partially reduces amplitude of the vibrational sounds. In this example, the reducing signal emitted from the two exciting transducers (106) excites the air inside the case (108) to attenuate the vibrational sounds outside the cake (114) and inside the case (108), thereby also attenuating the vibrational sounds outside the case (108). As a result, the vibrational sounds are reduced inside of the additive manufacturing device (102). In some examples, it is desirable not to adversely affect the evacuation process for the cake (114). As a result, the reducing signal is such that the reducing signal does not propagate into the build area (112).

FIG. 3C is a diagram of a system for reducing vibrational sounds produced during an evacuation process, according to one example of principles described herein. As will be described below, two exciting transducers (106) are used to transmit the reducing signal.

In an example, the vibrational sounds travel in the directions of arrow 308 when the shaker (104) vibrates. This causes the walls (110) of the build chamber (134) to oscillate in these directions. In an example, two exciting transducers (106) are used to transmit the reducing signal. The sound emitting sides of the two exciting transducers (106) are directed in the same direction as arrow 308 as illustrated by the arrows associated with the two exciting transducers (106). The reducing signal is transmitted such that the reducing signal at least partially reduces amplitude of the vibrational sounds. In some examples, it is desirable not to adversely affect the evacuation process for the cake (114). As a result, the reducing signal is such that the reducing signal does not propagate into the build area (112) since the reducing signal is not directed towards the build area (112).

Due to the use of two exciting transducers (106), the cost for an additive manufacturing apparatus (102) can be lower than an additive manufacturing apparatus (102) with more than two exciting transducers (106). However, the number of exciting transducers that are needed increases with case size, such as length and width, and with frequency as acoustic wavelength shortens. As a result, the additive manufacturing apparatus (102) can include more than two exciting transducers. Further, the use of exciting transducers (106) is more cost effective than using soundproofing materials such as baffling and insulation material. Using exciting transducers (106) does not significantly grow the size of the additive manufacturing apparatus (102). This provides more flexibility on the design and material selection of the additive manufacturing apparatus (102). As a result, the additive manufacturing apparatus (102) does not have to be redesigned when updating vibrational components or other components of the additive manufacturing apparatus (102).

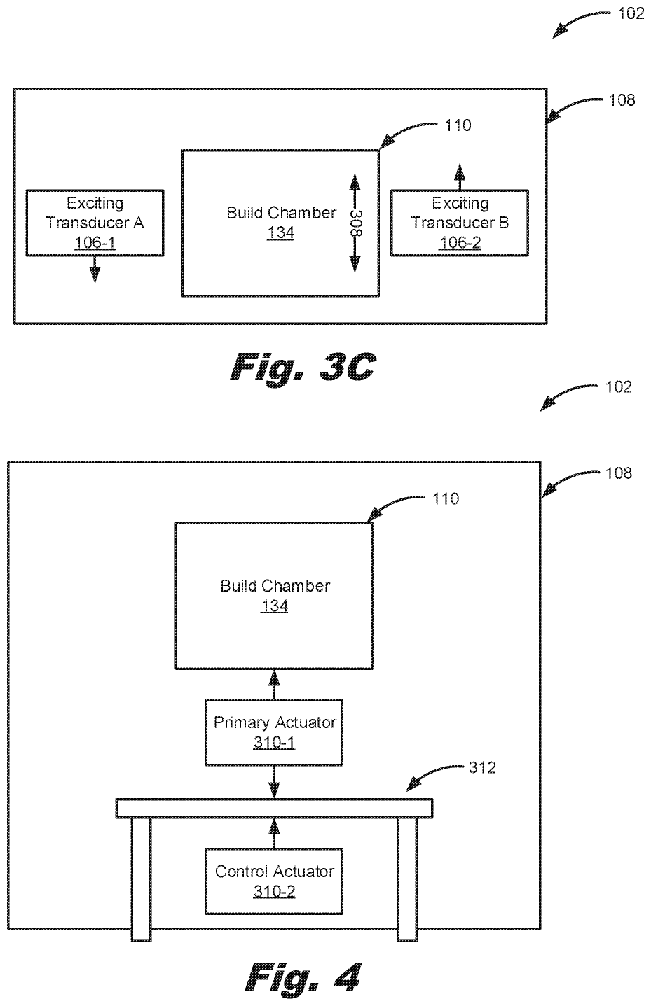

FIG. 4 is an alternate diagram of a system for reducing vibrational sounds produced during an evacuation process, according to one example of principles described herein. As will be described below, a primary actuator (310-1) is the shaker and a control actuator (310-2) is used instead of the exciting transducer to transmit the reducing signal. As a result, the primary actuator (310-1) is used to produce structure-bome vibrational sounds and the control actuator (310-2) is used to reduce the structure-borne vibrational sounds.

As illustrated, the primary actuator (310-1) acts as the shaker. The primary actuator (310-1) is connected to the build chamber (134) and a support structure (312) such that the actuator (310-1) can vibrate the build chamber (134) and/or build area (112).

The support structure (312) is connected to a control actuator (310-1) and the case (108) of the additive manufacturing apparatus (102). In this example, the control actuator (310-1) acts as the exciting transducer (106) described above. However, instead of using a reducing signal that is based on a sound wave. The control actuator (310-1) oscillates to provide the reducing signal.

While FIG. 4 has be described an illustrated as including one primary actuator (i.e. shaker) and one control actuator (i.e. a function of the exciting transducer), in practice, more than one primary actuator and one control actuator can be used. In one example, two primary actuators and one control actuator can be used. In another example, three primary actuators and two control actuators can be used. In yet another example, one primary actuator and two control actuators can be used. As a result, single or multiple shakers and single or multiple exciting transducers can be used.

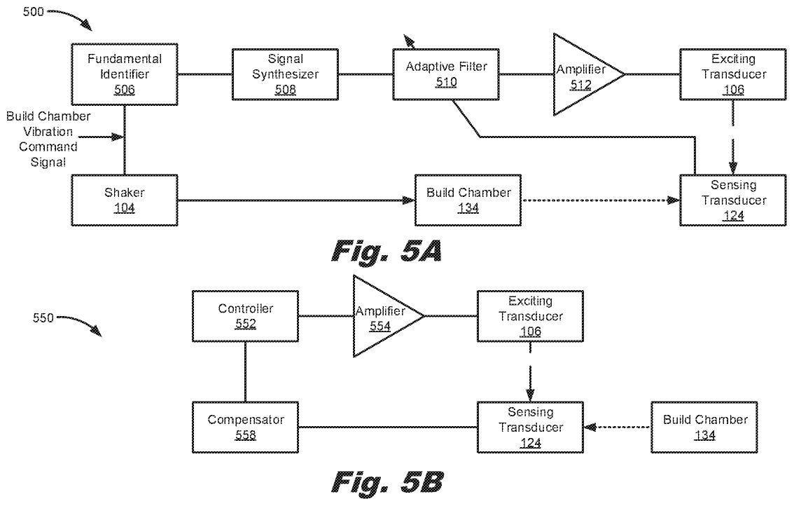

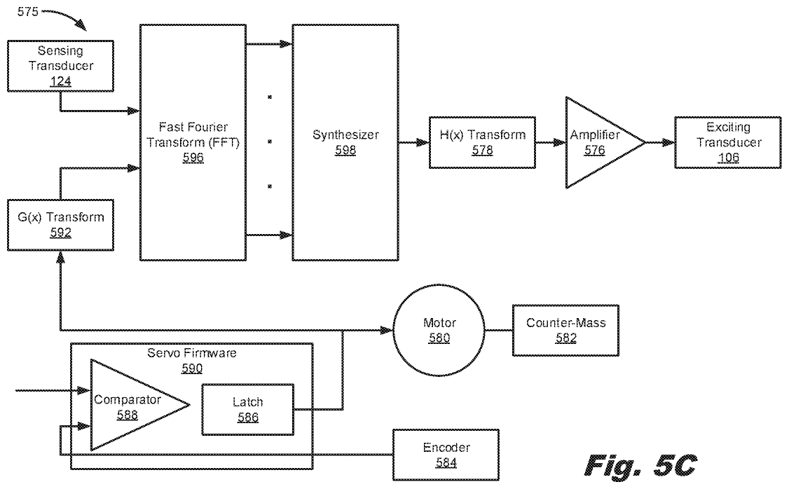

FIG. 5A is a feedforward control diagram for reducing vibrational sounds produced during an evacuation process, according to one example of principles described herein. The feedforward control diagram described component that are used to reduce vibrational sounds.

As illustrated, the diagram (500) includes a shaker (104). The shaker (104) vibrates the build chamber (134) as described above. Further, the error signal sensor(s), which may be microphone(s), accelerometer(s) or both, (124) receives the vibrational sounds as indicated by the dotted arrow.

The diagram (500) includes a fundamental identifier (506). The fundamental identifier (506) identifies the fundamental frequency or rate in a vibration actuation signal from the vibration command signal. The fundamental identifier (506) is connected to a signal synthesizer (508). The signal synthesizer (508) uses the fundamental frequency to generate sinusoids at the fundamental frequency and its integer multiple harmonics, that are synchronous with the vibration actuation signal.

The signal synthesizer (508) is connected to an adaptive filter (510). The adaptive filter (510) modifies each of the harmonic sinusoids by adjusting their sine and cosine components according to weights that adapt and change so as to minimize error signals delivered by the sensing transducers (124) such as microphones and/or accelerometers. This produces the reducing signal. The reducing signal is sent to an amplifier (512) to amplify the reducing signal. After the reducing signal is amplified, the reducing signal is transmitted via the exciting transducer (106). The exciting transducer (106) transmits the reducing signal as described above.

FIG. 5B is a feedback control diagram for reducing vibrational sounds produced during an evacuation process, according to one example of principles described herein. As will be described below, the diagram (550) includes a compensator (558), a controller (552), an amplifier (554), an acoustic or vibration transducer(s) (106), a sensing transducer such as a sensing transducer (124) and a build chamber (134).

As illustrated, the sensing transducers (124) receive the reducing signal from the exciting transducer (106) and the vibrational sounds from the build chamber (134). The sensing transducer (124) is connected to a compensator (558). The compensator (558) is a filter that offsets or smooths the plant dynamics between actuation signal(s) and sensor response signal(s) to promote controllability by the increase of gain and phase margins. The gain margin is the magnitude response where the phase response is 180 degrees. The phase margin is the phase response where the magnitude response is 0 decibel (dB).

The compensator (558) is connected to the controller (552). The controller (552) is a filtering element that is analog or digital that transforms error signals into actuation signals. In classical feedback control the controller involves a combination of scaling, differentiation, and integration. This produces the reducing signal. The reducing signal is sent to an amplifier (554) to amplify the reducing signal. After the reducing signal is amplified, the reducing signal is transmitted via the exciting transducer (106). The exciting transducer (106) transmits the reducing signal as described above.

FIG. 5C is a system diagram for reducing vibrational sounds produced during an evacuation process, according to one example of principles described herein. As will be described below, a number of components of the diagram (575) are used to produce the reducing signal.

The diagram (575) includes motor (580). The motor (508) is attached to a counter-mass (582). As the motor (508) rotates the counter-mass (582), and acts the actuator described above.

The diagram (575) includes an encoder (584). The encoder (584) this is an optical position encoder that provides feedback on motor movement. A velocity is typically commanded to the motor (580) and the servo firmware (590) adjusts the drive signal to maintain the target velocity.

The diagram (575) includes servo firmware (590). This label is to denote that the comparator (588) and latch (586) functions are implemented in firmware and not just hardware. In some examples, the servo firmware (590) could be implemented in continuous time in analog hardware. The servo firmware (590) includes the amplifier (588) and a latch (586). The comparator (588) receives a command. This command is from higher-level firmware function that instructs the system to vibrate the shaker (104) at a particular amplitude and/or frequency. The commanded value is based upon other system inputs, or by a higher-level algorithm on how to best separate unfused build material from fused build material. The latch (586) is used by firmware to provide accurate time sampling of the servo velocity error (i.e. the output of the comparator). This error signal is sampled at a 5 hertz rate, then the latched result can be used to calculate the drive response to the motor (580).

The diagram (575) includes a G(x) transform (592). The G(x) transform (592) represents a transform function that converts the motor drive signal (i.e. amplitude and frequency) into a particular expected audio response. This is used for the option where a sensing transducer is not used to provide a measure of the vibrational sounds. The G(x) transform (592) includes some adjustment based upon how the vibrational sounds is actually perceived from the user's frame of reference, so it may include filters to represent how various structural elements could influence the perceived sound.

The diagram (575) includes a sensing transducer (124), which is optional, and provides the same function as the actuation plus G(x) transform (592) described in the previous paragraph. Either the G(x) transform (592), or the sensing transducer (124), or both, sends a signal to the fast fourier transform (596). The fast fourier transform (596) computes the discrete fourier transform (DFT) of a sequence or its inverse such as component frequencies. The outputs of the fast fourier transform (596) are used as inputs for a synthesizer (598)

The synthesizer (598) uses the component frequencies multiplied by weighting factors to produce the inverse of the vibrational sounds. In some example, the vibrational sounds are converted to the frequency domain first, in order to fully analyze the frequency and phase components of the vibrational sounds.

The synthesizer (598) sends a signal to a H(x) transform (578). The H(x) transform (578) represents the process of modifying the reducing signal to what is needed from the user's frame of reference. It may include filtering to adjust the reducing signal to account for interaction with structural elements, so that the audio counter-measure signal exactly reduces the vibrational sounds at the user's frame of reference. The H(x) transform (578) sends the reducing signal to an amplifier (576) to amplify the reducing signal. After the reducing signal is amplified, the reducing signal is transmitted via the exciting transducer (106).

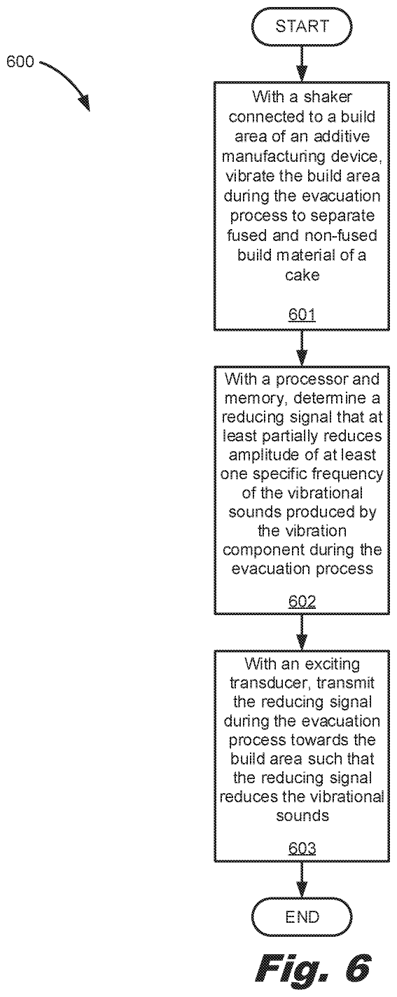

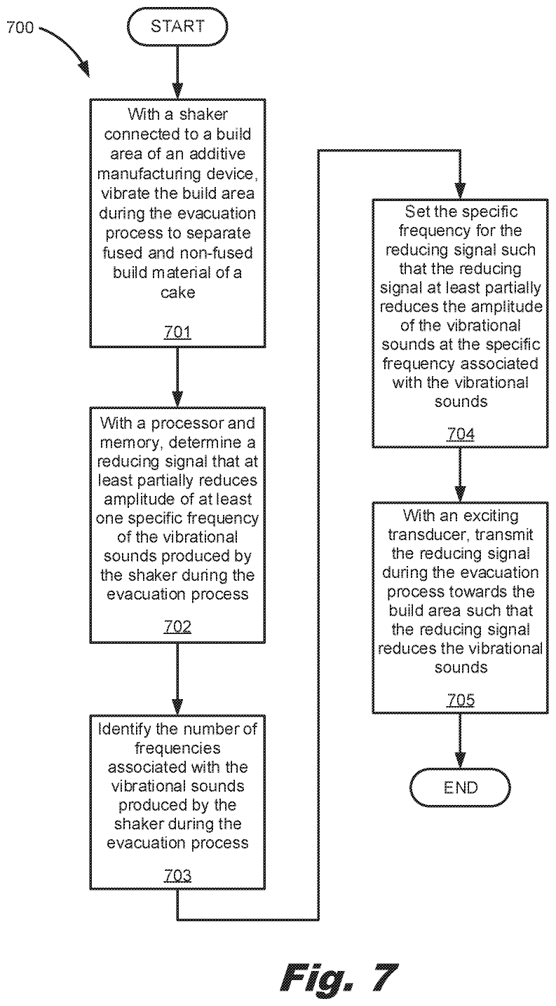

FIG. 6 is a flowchart of a method for reducing vibrational sounds produced during an evacuation process, according to one example of principles described herein. In one example, the method (300) may be executed by the additive manufacturing apparatus (102) of FIG. 1A or the systems of FIG. 2, 3, 4, or 5. In this example, the method (600) includes with a shaker connected to a build area of an additive manufacturing device, vibrating (601) the build area during the evacuation process to separate fused and non-fused build material of a cake, with a processor and memory, determining (602) a reducing signal that at least partially reduces amplitude of at least one specific frequency of the vibrational sounds produced by the shaker during the evacuation process and with an exciting transducer, transmitting (603) the reducing signal during the evacuation process towards the build area such that the reducing signal reduces the vibrational sounds.

As mentioned above, the method (600) includes with a shaker connected to a build area of an additive manufacturing device, vibrating (601) the build area during the evacuation process to separate fused and non-fused build material of a cake. In some examples, the shaker vibrates the build area at specific frequencies for durations of time. For example, the shaker vibrates the build area at 50 hertz for 30 seconds and 70 hertz for 45 seconds. In other examples, the shaker vibrates the build area at a specific frequency for a duration of time. For example, the shaker vibrates the build area at 50 hertz for 30 seconds.

As mentioned above, the method (600) includes with a processor and memory, determining (602) a reducing signal that at least partially reduces amplitude of at least one specific frequency of the vibrational sounds produced by the shaker during the evacuation process. In an example, the reducing signal at least partially reduces amplitude of the vibrational sounds at all frequencies associated with the vibrational sounds. In another example, the reducing signal at least partially reduces amplitude of at least one specific frequency of the vibrational sounds. In an example, the reducing signal at least partially reduces amplitude of at least one specific frequency of the vibrational sounds without adversely affecting the evacuation process for the cake. Further, the reducing signal at least partially reduces amplitude of at least one specific frequency of the vibrational sounds before the vibrational sounds reach a user. As a result, the vibrational sounds are attenuated when heard by the user.

As mentioned above, the method (600) includes with an exciting transducer, transmitting (603) the reducing signal during the evacuation process towards the build area such that the reducing signal reduces the vibrational sounds. In some example, the reducing signal is transmitted via a single exciting transducer. In other examples, the reducing signal is transmitted via a plurality of exciting transducers. Further, each of the plurality of exciting transducers transmits the same reducing signal. In another example, each of the plurality of exciting transducers transmits a different reducing signal.

FIG. 7 is a flowchart of a method for reducing vibrational sounds produced during an evacuation process, according to one example of principles described herein. In one example, the method (700) may be executed by the additive manufacturing apparatus (102) of FIG. 1A or the systems of FIG. 1, 2, 3, 4 or 5. In this example, the method (700) includes with a shaker connected to a build area of an additive manufacturing device, vibrating (701) the build area during the evacuation process to separate fused and non-fused build material of a cake, with a processor and memory, determining (702) a reducing signal that at least partially reduces amplitude of at least one specific frequency of the vibrational sounds produced by the shaker during the evacuation process, identifying (703) the number of frequencies associated with the vibrational sounds produced by the shaker during the evacuation process, setting (704) the specific frequency for the reducing signal such that the reducing signal at least partially reduces the amplitude of the vibrational sounds at the specific frequency associated with the vibrational sounds and with an exciting transducer, transmitting (705) the reducing signal during the evacuation process towards the build area such that the reducing signal reduces the vibrational sounds.

As mentioned above, the method (700) includes identifying (703) the number of frequencies associated with the vibrational sounds produced by the shaker during the evacuation process. In an example, the method (700) identifies all frequencies associated with the vibrational sounds produced by the shaker during the evacuation process. In another example, the method identifies specific frequencies associated with the vibrational sounds produced by the shaker during the evacuation process.

As mentioned above, the method (700) includes setting (704) the specific frequency for the reducing signal such that the reducing signal at least partially reduces the amplitude of the vibrational sounds at the specific frequency associated with the vibrational sounds. This includes applying a weight to specific frequency. The weight may include how intense the reducing signal for that frequency is. The weight may be symbolic such as low, medium or high. The weight may be a range such as 0 to 10.

The preceding description has been presented to illustrate and describe examples of the principles described. This description is not intended to be exhaustive or to limit these principles to any precise form disclosed. Many modifications and variations are possible in light of the above teaching.

What is claimed is:

1. An additive manufacturing device comprising:
a shaker connected to a build area of the additive manufacturing device, the shaker to vibrate the build area during the evacuation process to separate fused and non-fused build material of a cake; and
an exciting transducer to transmit a reducing signal during the evacuation process such that the reducing signal reduces vibrational sounds produced by the shaker before the vibrational sounds reaches a user.

2. The additive manufacturing device of claim 1, wherein the exciting transducer is located between a case of the additive manufacturing device and a wall of a build chamber.

3. The additive manufacturing device of claim 1, wherein the reducing signal is predetermined at time of manufacture of the additive manufacturing device by:
characterizing an acoustical signature of the additive manufacturing device to identify frequencies of the vibrational sounds during the evacuation process;
based on the frequencies of the vibrational sounds, determining specific frequencies that are to be reduced;
setting the specific frequencies for the reducing signal such that the reducing signal at least partially reduces amplitude of the vibrational sounds at the specific frequencies associated with the vibrational sounds; and
storing the reducing signal in memory.

4. The additive manufacturing device of claim 1, wherein the reducing signal is produced during the evacuation process by:
with a sensing transducer, receiving vibrational sounds during the evacuation process;
with a circuit, determining specific frequencies of the vibrational sounds that are to be reduced and setting the specific frequencies for the reducing signal such that the reducing signal at least partially reduces amplitude of the vibrational sounds at the specific frequencies associated with the vibrational sounds; and
with the exciting transducer, transmitting the reducing signal during the evacuation process.

5. The additive manufacturing device of claim 1, wherein the reducing signal at least partially reduces amplitude of the vibrational sounds at all frequencies associated with the vibrational sounds.

6. The additive manufacturing device of claim 1, wherein the reducing signal at least partially reduces amplitude of at least one specific frequency of the vibrational sounds.

7. A system for reducing vibrational sounds produced during an evacuation process, the system comprising:
a shaker connected to a build area of an additive manufacturing device, the shaker to vibrate the build area during the evacuation process to separate fused and non-fused build material of a cake; and
an array of exciting transducers to transmit a reducing signal during the evacuation process towards the build area such that the reducing signal reduces the vibrational sounds produced by the shaker;
wherein the array of exciting transducers at least partially reduce amplitude of at least one specific frequency of the vibrational sounds via the reducing signal.

8. The system of claim 7, wherein the array of the exciting transducers is located between a case of the additive manufacturing device and a wall of a build chamber.

9. The system of claim 7, wherein the array of the exciting transducers is located external to the additive manufacturing device.

10. The system of claim 7, wherein sound emitting sides of a first portion of the exciting transducers are positioned at an obtuse angle relative to sound emitting sides of a second portion of the exciting transducers.

11. The system of claim 7, wherein a first portion of the exciting transducers is located between a case of the additive manufacturing device and a wall of the build area and a second portion of the exciting transducers is located external to the additive manufacturing device.

12. A method for reducing vibrational sounds produced during an evacuation process, the method comprising:
with a shaker connected to a build area of an additive manufacturing device, vibrating the build area during the evacuation process to separate fused and non-fused build material of a cake;
with a processor and memory, determining a reducing signal that at least partially reduces amplitude of at least one specific frequency of the vibrational sounds produced by the shaker during the evacuation process; and
with an exciting transducer, transmitting the reducing signal during the evacuation process towards the build area such that the reducing signal reduces the vibrational sounds.

13. The method of claim 12, further comprising identifying the number of frequencies associated with the vibrational sounds produced by the shaker during the evacuation process.

14. The method of claim 12, wherein the exciting transducers are located between a case of the additive manufacturing device and a wall of a build chamber.

15. The method of claim 12, further comprising setting the specific frequency for the reducing signal such that the reducing signal at least partially reduces the amplitude of the vibrational sounds at the specific frequency associated with the vibrational sounds.
